(19) United States
(12) Patent Application Publication
(10) Pub. No.: US 2017/0353737 A1
(43) Pub. Date: Dec. 7, 2017

(54) Method and Apparatus of Boundary Padding for VR Video Processing

(71) Applicant: MEDIATEK INC., Hsin-Chu (TW)

(72) Inventors: Jian-Liang LIN, Su'ao Township (TW); Hung-Chih LIN, Caotun Township (TW); Chia-Ying LI, Taipei City (TW); Chao-Chih HUANG, Zhubei City (TW); Shen-Kai CHANG, Zhubei City (TW)

(21) Appl. No.: 15/614,754

(22) Filed: Jun. 6, 2017

Related U.S. Application Data
(60) Provisional application No. 62/346,597, filed on Jun. 7, 2016.

(51) Int. Cl. H04N 19/597; H04N 19/172; H04N 19/426; H04N 19/88

(52) U.S. Cl. CPC H04N 19/597; H04N 19/88; H04N 19/172; H04N 19/426

(57) ABSTRACT

A method and apparatus or video coding or processing for an image sequence corresponding to virtual reality (VR) video are disclosed. According to embodiments of the present invention, a padded area outside one cubic face frame boundary of one cubic face frame is padded to form a padded cubic face frame using one or more extended cubic faces, where at least one boundary cubic face in said one cubic face frame has one padded area using pixel data derived from one extended cubic face in a same cubic face frame.

### CROSS REFERENCE TO RELATED APPLICATIONS

The present invention claims priority to U.S. Provisional Patent Application, Ser. No. 62/346,597, filed on Jun. 7, 2016. The U.S. Provisional Patent Application is hereby incorporated by reference in its entirety.

### FIELD OF THE INVENTION

The present invention relates to image and video coding and processing. In particular, the present invention relates to padding cubic face frames for video coding or processing that requires pixel data outside the cubic face frame boundary.

### BACKGROUND AND RELATED ART

The 360-degree video, also known as immersive video is an emerging technology, which can provide “feeling as sensation of present”. The sense of immersion is achieved by surrounding a user with wrap-around scene covering a panoramic view, in particular, 360-degree field of view. The “feeling as sensation of present” can be further improved by stereographic rendering. Accordingly, the panoramic video is being widely used in Virtual Reality (VR) applications.

Immersive video involves the capturing a scene using multiple cameras to cover a panoramic view, such as 360-degree field of view. The immersive camera usually uses a set of cameras, arranged to capture 360-degree field of view. Typically, two or more cameras are used for the immersive camera. All videos must be taken simultaneously and separate fragments (also called separate perspectives) of the scene are recorded. Furthermore, the set of cameras are often arranged to capture views horizontally, while other arrangements of the cameras are possible.

The 360-degree panorama camera captures scenes all around and the stitched spherical image is one way to represent the VR video, which continuous in the horizontal direction. In other words, the contents of the spherical image at the left end continue to the right end. The spherical image can also be projected to the six faces of a cube as an alternative 360-degree format. The conversion can be performed by projection conversion to derive the six-face images representing the six faces of a cube. On the faces of the cube, these six images are connected at the edges of the cube. In FIG. 1, image 110 corresponds to an assembled rectangular cubic frame without any blank area, where the assembled frame consists of 1×6 cubic faces. In FIG. 1, image 120 corresponds to an unfolded cubic image with blank areas filled with dummy data, which is also referred as a cubic net with blank areas. As shown in FIG. 1, the unfolded cubic-face images are fitted into a smallest rectangular that covers the six unfolded cubic-face images.

The cubic-face assembled frames often require additional processing such as video/image compression or image filtering. For example, in conventional video coding systems, the processes of motion estimation (ME) and motion compensation (MC) may require image data outside or crossing frame boundary of the reference frame. Unlike the conventional 2D video, the frames associated with 360-degree video have continuity between neighboring cubic faces. A video/image system aware of the continuity between cubic faces should be able to perform better by utilizing such information. In the present invention, boundary processing is disclosed for VR video to take advantage of the knowledge of continuity between cubic faces.

### BRIEF SUMMARY OF THE INVENTION

A method and apparatus or video coding or processing for an image sequence corresponding to virtual reality (VR) video are disclosed. According to embodiments of the present invention, a padded area outside one cubic face frame boundary of one cubic face frame is padded to form a padded cubic face frame using one or more extended cubic faces, where at least one boundary cubic face in said one cubic face frame has one padded area using pixel data derived from one extended cubic face in a same cubic face frame. Said one cubic face frame may correspond to one 1×6 cubic layout, 2×3 cubic layout, 3×2 cubic layout or a cubic net with blank areas. Said coding the current cubic face frame may use Inter prediction and said one cubic face frame corresponds to one reference cubic face frame coded prior to the current cubic face frame.

According to one embodiment, for a target boundary cubic face edge, one extended cubic face sharing the target boundary cubic face edge with a corresponding boundary cubic face is copied to a corresponding padded area for the corresponding boundary cubic face. If one or more corner areas at corners of the padded area has no corresponding boundary cubic face to derive padded data, one or more neighboring boundary cubic faces are used to derive pixel data in one corner area. Line-based padding, circular-based padding, point-based padding or area-based padding can be used to derive the pixels data in one corner of the padded area. When line-based padding is used, a line connecting two corresponding boundary pixels from two neighboring cubic faces of one corner area is assigned a same pixel value. When circular-based padding is used, a circular curve connecting two corresponding boundary pixels from two neighboring cubic faces of one corner area is assigned a same pixel value, and wherein said same pixel value corresponds to a pixel value of one of the two corresponding boundary pixels or a weighted sum of the two corresponding boundary pixels. When point-based padding is used, one corner area is assigned a same pixel value corresponding to a pixel value of a corner pixel or another pixel in two neighboring cubic faces of said one corner area. The pixel value may correspond to one boundary pixel after filtering. When area-based padding is used, one corner area is filled using one of two neighboring cubic faces of said one corner area, or said one corner area is split into two sub-corner areas and filled with corresponding sub-cubic faces of said two neighboring cubic faces.

According to one embodiment, continuous padding is disclosed, where a target extended cubic face sharing one or more boundary cubic face edges with one or more corresponding boundary cubic faces is used to derive a corresponding padded area for a target side of the corresponding boundary cubic face, and wherein said one or more boundary cubic face edges align with the target side of the corresponding boundary cubic face. The target extended cubic face is partitioned into multiple regions and each region comprises one cubic face edge of the target extended cubic face, and wherein each region is used to fill a corresponding padded region for a boundary cubic face sharing a same cubic face edge with said each region. The heights of the multiple regions measured from the frame boundary are adjusted to be a same height. A blank region between two padded regions can be filled by using interpolation from two corresponding boundary pixels of said two padded regions or by using a same value along each line connecting two corresponding boundary pixels of said two padded regions, and wherein said same value corresponds to one of two pixel values of two boundary pixels of the two padded regions.

In the continuous padding, a corner area adjacent to one extended cubic face and one padded region filled by one region of the target extended cubic face can be filled using line-based padding, circular-based padding or point-based padding according to boundary pixels or a corner pixel of one or more neighboring cubic faces. If a total number of different boundary cubic face edges shared between said one or more corresponding boundary cubic faces and the target extended cubic face is three: the target extended cubic face is partitioned into one first triangle and two second triangles, wherein the first triangle corresponds to an isosceles triangle having one boundary cubic face edge as a base side and having a first height of isosceles triangle equal to a length of one cubic face edge; each second triangle corresponds to one right-angle triangle having one boundary cubic face edge as a long adjacent side to a right angle and a length of a short adjacent side to the right angle is equal to a half of the length of one cubic face edge, wherein the second triangle has a second height equal to one half of the length of one cubic face edge when the long adjacent side is considered as a base side to fill a padded region for one boundary cubic face sharing one cubic face edge; and the first height and the second height are adjusted to be the same. If a total number of different boundary cubic face edges shared between said one or more corresponding boundary cubic faces and the target extended cubic face is four: the target extended cubic face is partitioned into four equal-sized isosceles triangles, wherein each triangle has one boundary cubic face edge as a base side and having a first height of isosceles triangle equal to half length of one cubic face edge.

If the cubic face frame corresponds to a cubic net with blank areas, at least one blank area is padded using one extended cubic face. For a target block in a target boundary cubic face being coded or processed, said one extended cubic face is used to fill said at least one blank area, wherein said one extended cubic face is selected to share a same cubic face edge with the target boundary cubic face. In one embodiment, said one blank area is partitioned into multiple blank regions and each blank region is padded using one corresponding boundary cubic face sharing one cubic edge with said each blank region. A corresponding region of said one corresponding boundary cubic face can be used to fill said each blank region. In another embodiment, for each blank region, a same value is assigned along a line from a corresponding boundary cubic face edge of said one corresponding boundary cubic face to a corner of said each blank region located at a center of said one blank area.

In one embodiment, if the cubic face frame corresponds to a cubic net with blank areas, at least one blank area is padded according to line-based padding, circular-based padding or point-based padding using pixel data from neighboring cubic faces. When one extended cubic face is used to fill one blank area or a partial blank area, alphas blending can be applied along two neighboring shared cubic face edges. A weighting factor for alpha blending can be determined according to perpendicular distances to a starting point of extension.

In another embodiment, the method may further comprise signaling or parsing one or more padding modes assigned to each padding area or region. The padding modes for neighboring cubic faces can be determined and a current padding mode for a current cubic face can be signaled or parsed only if the current padding mode is ambiguous.

### BRIEF DESCRIPTION OF THE DRAWINGS

FIG. 1 illustrates examples of assembled rectangular cubic frame without any blank area and an unfolded cubic image with blank areas filled with dummy data.

FIG. 2 illustrates examples of circular cubic face edges labelled for assembled rectangular cubic frame without any blank area and the unfolded cubic image with blank areas filled with dummy data in FIG. 1.

FIG. 3 illustrates an example of padding process for VR video coding, where an input cubic-face frame corresponding to a 3×2 assembled frame is padded into a padded frame.

FIG. 4 illustrates an example of padding for a 1×6 cubic-face assembled frame according to an embodiment of the present invention.

FIG. 5 illustrates an example of unfilled corners of padded area after filling the padded area with extended cubic faces.

FIG. 6A illustrates an example of padding an upper-right unfilled corner using line-based padding, where each line is assigned a value from a single pixel (e.g. a boundary pixel).

FIG. 6B illustrates an example of padding an upper-right unfilled corner using line-based padding, where each vertical line is assigned one value from one pixel and each horizontal line is assigned another value from another pixel.

FIG. 6C illustrates an example of padding an upper-right unfilled corner using circular-based padding, where each circular line is assigned a value from a single pixel or a weighted sum of two pixels from two boundaries.

FIG. 6D illustrates an example of padding an upper-right unfilled corner using point-based padding, where the corner pixel is extended to the unfilled corner area.

FIG. 7A illustrates an example of filling the unfilled corner area by rotating the cubic face on the bottom edge of the corner area counterclockwise by 90 degrees and filling the area using the rotated cubic face.

FIG. 7B illustrates an example of filling the unfilled corner area by rotating the cubic face on the left edge of the corner area clockwise by 90 degrees and filling the area using the rotated cubic face.

FIG. 8A illustrates an example of filling the upper-left half of the corner area using the upper-left half of the rotated cubic face below the corner area.

FIG. 8B illustrates an example of filling the lower-right half of the corner area using the lower-right half of the rotated cubic face from the left side of the corner area.

FIG. 9 illustrates an example of padding for a 2×3 cubic-face assembled frame and unfilled corners of padded area after filling the padded area with extended cubic faces according to an embodiment of the present invention.

FIG. 10 illustrates the case for padding the 1×6 cubic-face assembled frame, where the boundary between any two neighboring extended cubic faces used to fill the padded area is always discontinuous as indicated by dashed ellipses.

FIG. 11 illustrates the case for padding the 2×3 cubic-face assembled frame, where the boundary between any two neighboring extended cubic faces used to fill the padded area is always discontinuous as indicated by dashed ellipses.

FIG. 12 illustrates an example of discontinuities during padding the 2×3 cubic-face assembled frame, where the boundary between any two neighboring extended cubic faces used to fill the padded area is discontinuous as indicated by dashed ellipses.

FIG. 13 illustrates an example of continuous padding according to an embodiment of the present invention, where a target cubic face shares the same cubic-face edges with the bottom cubic faces of a cubic frame and the target cubic face is partitioned into multiple regions for continuous padding.

FIG. 14 illustrates an example of discontinuities during padding a cubic-face assembled frame, where the boundary between any two neighboring extended cubic faces used to fill the padded area is discontinuous as indicated by dashed ellipses.

FIG. 15 illustrates an example of continuous padding according to an embodiment of the present invention, where a target cubic face shares the same cubic-face edges with the bottom cubic faces of a cubic frame and the target cubic face is partitioned into multiple regions for continuous padding.

FIG. 16A illustrates an example of line-based padding to fill two corner areas.

FIG. 16B illustrates an example of circular-based padding to fill two corner areas.

FIG. 16C illustrates an example of point-based padding to fill two corner areas.

FIG. 17 illustrates another continuous padding technique, where the cubic face is equally partitioned into four equal-sized isosceles triangles and the base side of each triangle is associated with one cubic-face edge on the right side cubic boundary of image.

FIG. 18 illustrates an example of padding required for a blank area of an unfolded cubic net with blank areas, where the blank area is filled using interpolation or coping along the arrowed lines.

FIG. 19 illustrates an example of filling the blank area in an unfolded cubic face net using a rotated neighboring cubic face.

FIG. 20 illustrates another example of filling the blank area in an unfolded cubic-face net by divided the blank area into multiple regions and each region is padded independently.

FIG. 21 illustrates an example of partitioning a blank area in an unfolded cubic-face net into regions and filling each region using a boundary cubic face.

FIG. 22 illustrates an example of partitioning a blank area in an unfolded cubic-face net into four regions and filling each region by using a same pixel value for each line in the blank area.

FIG. 23 illustrates a point-based padding for a blank area in an unfolded cubic-face net, where the value of corner pixel or a pre-define value is used to fill the blank area.

FIG. 24 illustrates a line-based padding for a blank area in an unfolded cubic-face net, where interpolation is performed along lines using boundary pixel values to fill the blank area.

FIG. 25 illustrates circular-based padding for a blank area in an unfolded cubic-face net, where interpolation can be performed along circular lines using boundary pixel values to fill the blank area.

FIG. 26 illustrates an example of large motion vector pointing outside a 1×6 cubic-face assembled frame, where the padding technique is used as an example generate the needed data outside the cubic frame boundary.

FIG. 27 illustrates an example of a padded cubic-face frame having artifact.

FIG. 28 illustrates an example of determining the weights for the alpha blending.

FIG. 29 illustrates an example of applying alpha blending to two neighboring cubic faces to form a blended cubic face.

FIG. 30 illustrates an example of assigning padding modes for each padding region in a layout scheme, where dash-lines blocks indicate regions or areas to be padded.

FIG. 31 illustrates another example of assigning padding mode, where each face is coded and creates padding independently

FIG. 32 illustrates an exemplary flowchart of video coding or processing for an image sequence corresponding to virtual reality (VR) video according to an embodiment of the present invention

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

As mentioned before, the conventional video/image coding or conventional image processing treats the spherical images and the cubic images as regular frames from a regular video/image camera. When pixel data outside the boundaries are needed, the pixel data outside are often treated as unavailable data. Therefore, the unavailable pixel data are usually artificially generated such padding with pre-defined data or extending existing pixels near the boundaries. However, for cubic-face assembled frames do have continuity for data outside the cubic face boundaries. In the present invention, various data padding techniques by taking into account of the continuity across cubic-face boundaries are disclosed.

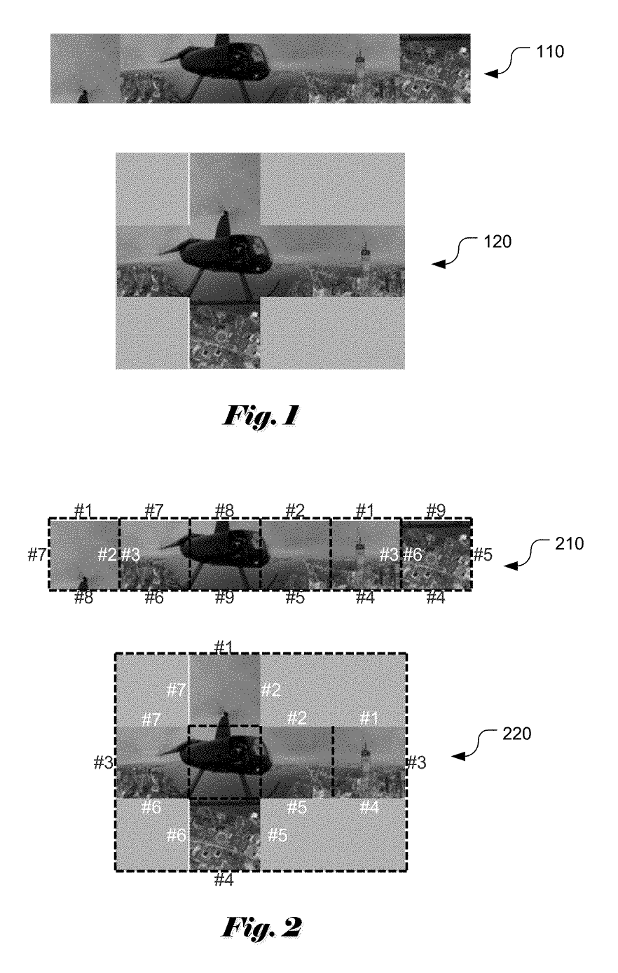

These six cube faces are interconnected in a certain fashion as shown in FIG. 1 since these six cubic faces are interconnected on the surface of a cubic. Accordingly, each edge on the cube is shared by two cubic faces. In other words, each four faces in the x, y and z directions are circular continuous. The circular edges for the 1×6 cubic-face assembled frame without blank areas (i.e. image 110 in FIG. 1) are illustrated by image 210 in FIG. 2. For each numbered edge, there is a corresponding edge from another cubic face. For example, edge #1 on the top side of the first cubic face on the left is connected to edge #1 on the top side of the second cubic face from the right. There is no edge labelled for the middle four cubic faces of image 110 since these four cubic faces are continuous and no edge is visible between any two neighboring cubic images. However, for these four cubic faces, the left edge (i.e., edge #3) of the left-most image is wrapped around to connect to the right edge (i.e., edge #3) of the right-most cubic image. The circular edges for the cubic-face assembled frame with blank areas (i.e. image 120 in FIG. 1) are illustrated by image 220 in FIG. 2.

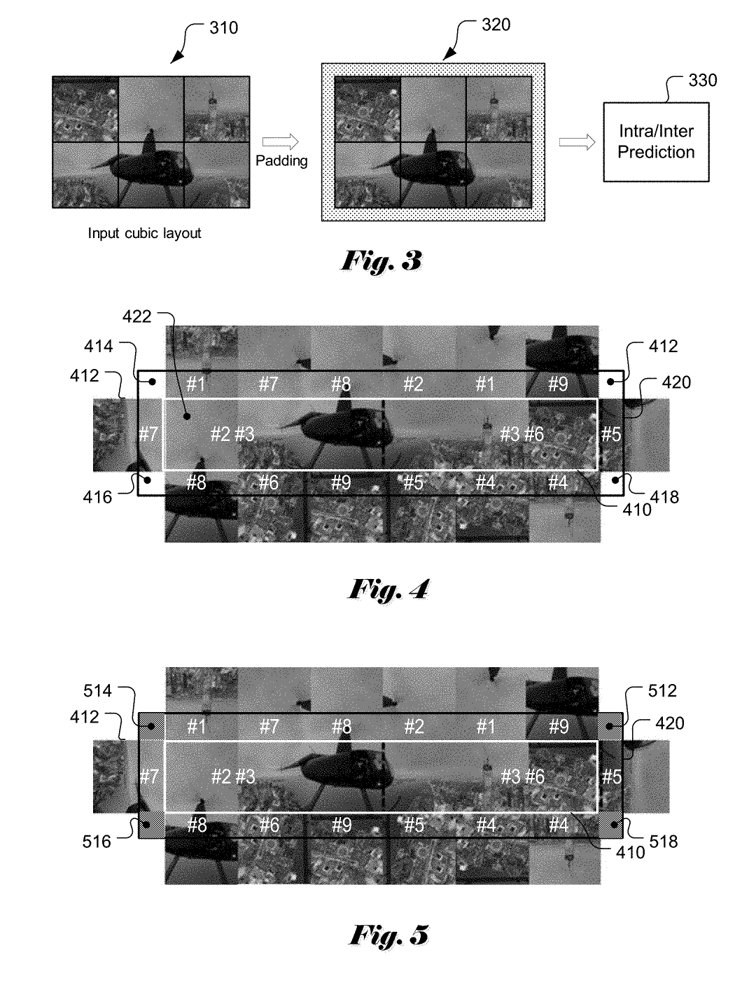

In the VR coding video, the information outside frame boundary can be obtained from other cubic faces. FIG. 3 illustrates an example of padding process for VR video coding, where an input cubic-face frame 310 (also named a cubic face layout or cubic layout) corresponding to a 3×2 assembled frame is padded into a padded frame 320. After the padding process, the conventional Inter/Intra prediction 330 can then be used to encode the video efficiently. In particular, the pixels outside image/video boundary are obtained from other face, which share the same cubic face boundary according to embodiments of the present invention.

FIG. 4 illustrates an example of padding for a 1×6 cubic-face assembled frame 410 according to an embodiment of the present invention. For each cubic-face edge of the frame boundary, a corresponding edge and associated cubic face is identified. For example, there is a cubic edge #7 on the left boundary of the assembled frame. The associated cubic face 412 will be used to generate the required padding data outside the left boundary. Any cubic face adjacent to the cubic-face frame boundary is referred as a boundary cubic face. For the 1×6 cubic-face frame, every cubic face is a boundary cubic face. Cubic face 412 and cubic face 422 share a same cubic-face edge (i.e., #7). Cubic face 412 used to derive extended pixel data outside a target cubic face 422 is a different cubic face from the target cubic face 422. The cubic face 412 is also referred as an extended cubic face in this disclosure. Similarly, all other cubic faces for the boundaries can be identified. Usually, only a limited number of pixels near the boundaries will be padded. Accordingly, only the pixels between area 420 and the 1×6 cubic-face assembled frame 410 need to be padded. However, for the four corners (i.e., 412, 414, 416 and 418) of the padded area, there is no data from neighboring cubic faces available. Therefore, these four unfilled corners have to be padded with padding data as indicated by areas 512, 514, 516 and 518 in FIG. 5.

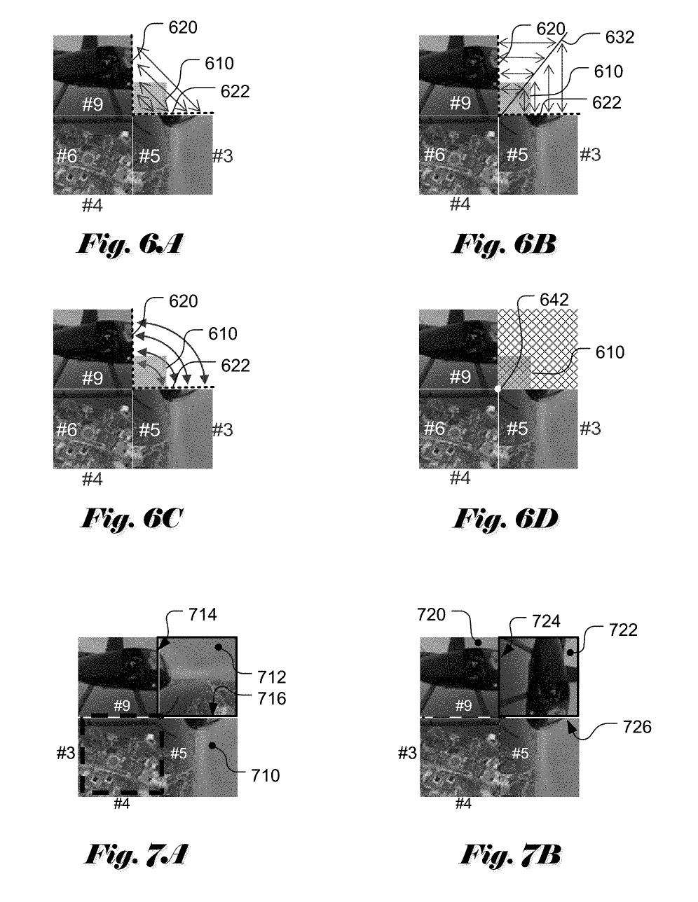

Various techniques to generate the padded data for the four unfilled corners of the padding area are disclosed. According to one embodiment, line-based padding is used by assigning a same value along each line. For example, the line can be obtained from the boundary of current face or from the boundary of the neighboring face as shown in FIG. 6A for the padding of upper-right corner area 610. The lines are shown as arrowed lines connecting the two neighboring cubic edges. The pixel value can be copied along the arrowed line from the pixels at the vertical edge 620 or from the horizontal edge 622. The line can be assigned a value from a single pixel or multiple pixels. For example, FIG. 6B illustrates an example of using two pixels for each line, where the line goes in the horizontal direction in the upper region of the diagonal line 632 and goes in the vertical direction in the lower region of the diagonal line 632. For the horizontal direction, the line copies pixel from the vertical edge 620 and for the vertical direction, the line copies pixels from the horizontal edge 622.

In another embodiment, circular-based padding is used by assigning a same value along each circular line as shown in FIG. 6C. The value can be derived from one of the boundary (i.e., 620 or 622) or a weighted sum of two pixels from two boundaries (i.e., 620 and 622). In yet another embodiment, point-based padding is used to generate padded data by extending the corner pixel 642 to the unfilled corner area as shown in FIG. 6D. In this case, the pixel value for pixels in the padding area is the same as the corner pixel 642.

In the above embodiment for padding the corner areas, the padding value can be filtered boundary pixels. In other words, filtering can be applied to boundary pixels and the filtered pixels are then used to generate the padding data.

Area-based padding technique is also disclosed for generating the padding data for the unfilled corner area. In one embodiment, one of the two boundary cubic faces is used to fill the unfilled corner area. For example, the cubic face 710 on the bottom edge of the corner area is used to fill the corner area as shown in FIG. 7A. In this case, cubic face 710 is rotated counterclockwise by 90 degrees to form a rotated cubic face 712 and is used to fill the corner space by rotating cubic face 710 counterclockwise by 90 degrees. Also, the cubic face 720 on the left edge of the corner area can be used to fill the corner area as shown in FIG. 7B. In this case, cubic face 720 is rotated clockwise by 90 degrees to form a rotated cubic face 722 and is used to fill the unfilled corner area. It is noted that the filled area is continuous on the left edge 714, but discontinuous on the bottom edge 716 in FIG. 7A. On the other hand, the filled area is continuous on the bottom edge 726, but discontinuous on the left edge 724 in FIG. 7B.

In FIG. 7A, the upper-left part of the filled area is continuous from the cubic face boundary. On the other hand, in FIG. 7B, the lower right part of the filled area is continuous from the cubic face boundary. Therefore, in another embodiment, half of each cubic face from both edges of the corner area is used to fill the corner area as shown in FIG. 8A and FIG. 8B. The upper-left half of cubic face 712 above the diagonal line is used to fill the upper-left half of the corner area above the diagonal line as shown in FIG. 8A. On the other hand, the lower-right half of cubic face 722 below the diagonal line is used to fill the lower-right half of the corner area below the diagonal line as shown in FIG. 8B.

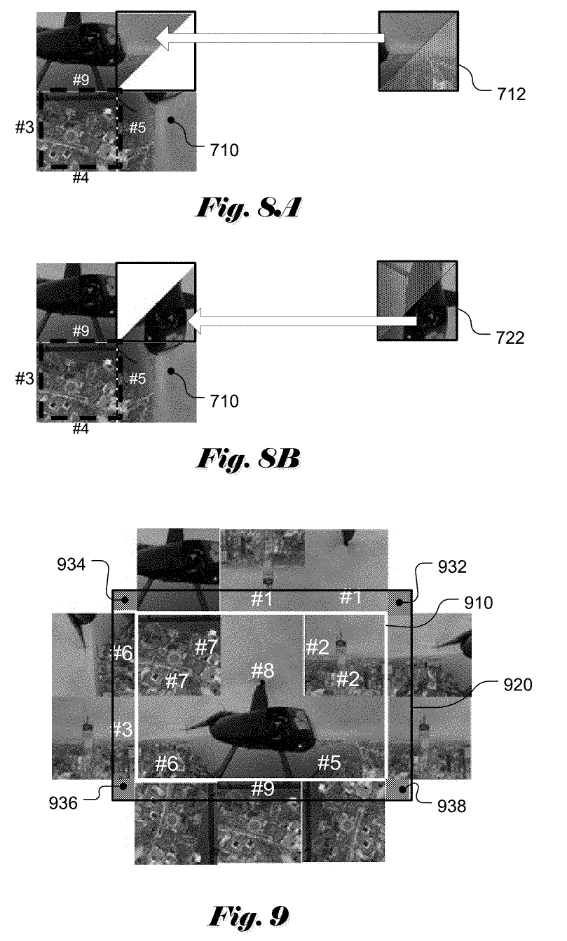

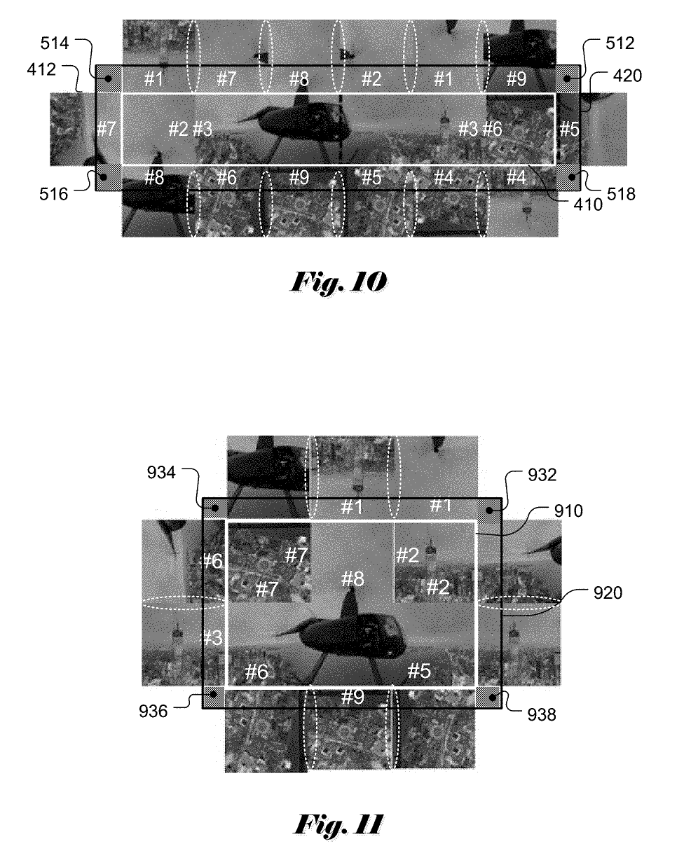

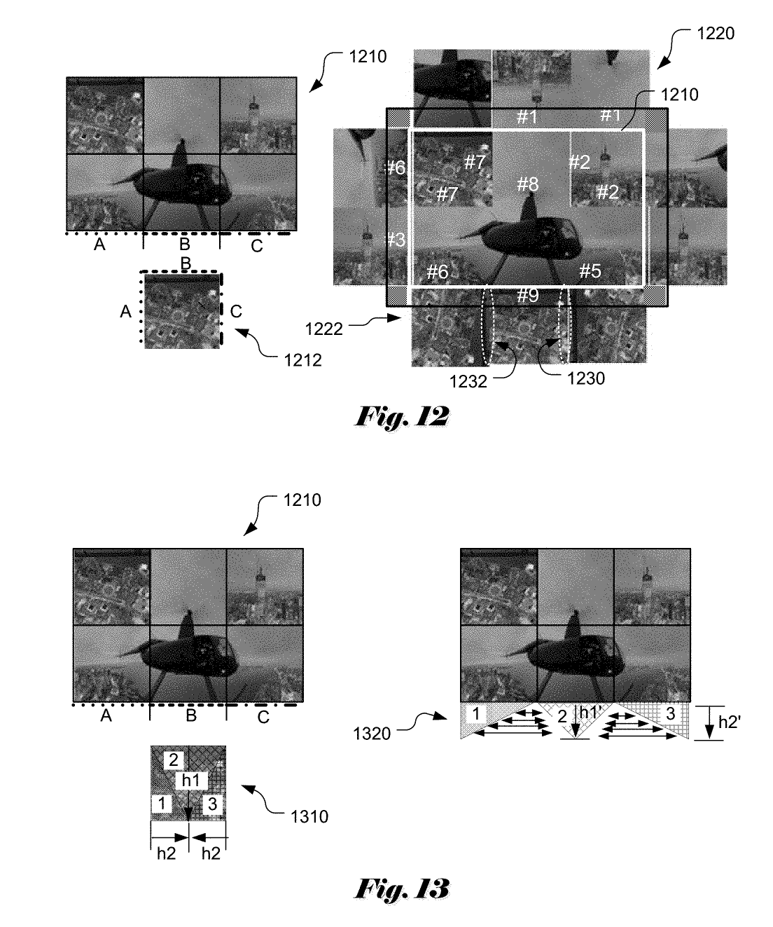

Other than the 1×6 cubic-face assembled frame, a 2×3 cubic-face assembled frame may also be used. FIG. 9 illustrates an example of padding for a 2×3 cubic-face assembled frame 910. Similar to the case for 1×6 cubic-face assembled frame in FIG. 5, the cubic faces sharing the same cubic edges are placed around the boundaries of the 2×3 cubic-face assembled frame 910. The area between block 920 and the 2×3 cubic-face assembled frame 910 is to be padded. Also, at the four corners of the to-be-filled area, the four-corner areas (932, 934, 936 and 038) have no neighboring cubic faces that can be used to fill the padded area. The padding techniques shown in FIGS. 6A-D, FIGS. 7A-B and FIGS. 8A-B are also applicable to the case in FIG. 9.

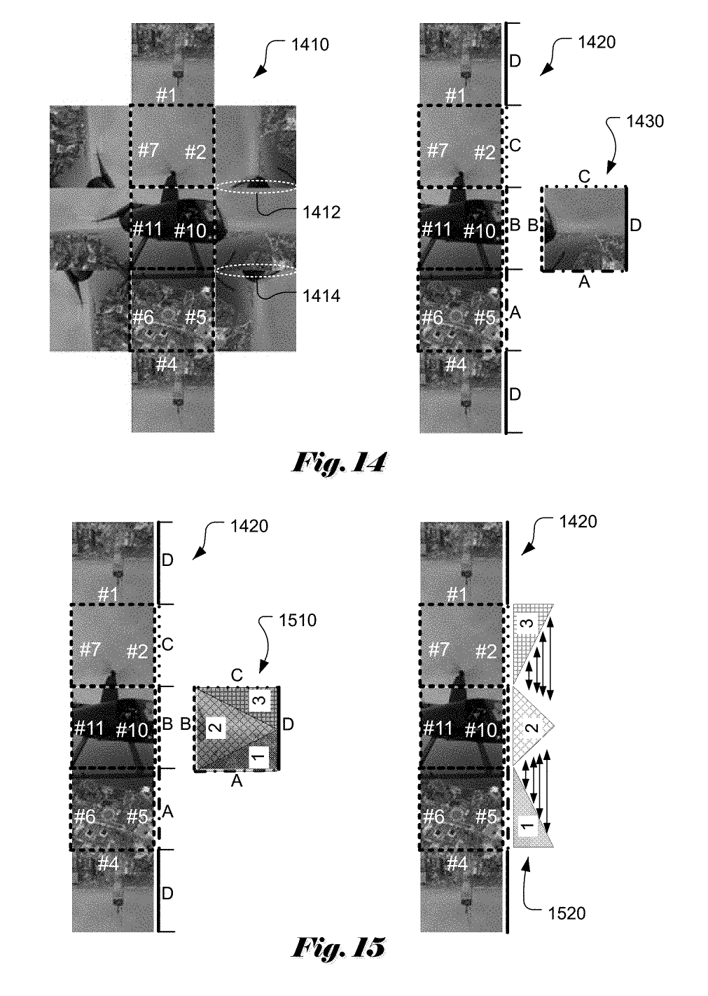

The padding techniques by using extended cubic faces sharing common edges result in continuous image across the frame boundaries. However, the area between two neighboring cubic faces used to fill the boundary area may not be continuous. FIG. 10 illustrates the case for padding the 1×6 cubic-face assembled frame. The boundary between any two neighboring extended cubic faces used to fill the padded area is always discontinuous as indicated by dashed ellipses as shown in FIG. 10. FIG. 11 illustrates the case for padding the 2×3 cubic-face assembled frame. The area between any two neighboring extended cubic faces used to fill the padded area is always discontinuous as indicated by dashed ellipses as shown in FIG. 11.

In order to overcome the discontinuity issue as illustrated in FIG. 10 and FIG. 11, continuous padding techniques are disclosed, which generate continuous padding area from one extended cubic face to another extended cubic face. FIG. 12 illustrates an example of continuous padding based on a cubic face 1212 (designated as a target cubic face). Cubic face 1212 has three shared cubic-face edges with the bottom boundary of the 2×3 cubic-face assembled frame 1210. The cubic face 1212 can be used to generate the padding data for the bottom area 1222 of the 2×3 cubic-face assembled frame 1210. The target cubic face 1212 has three edges (labelled as “A”, “B” and “C” in FIG. 12) shared with the cubic faces at the bottom row of the 2×3 cubic-face assembled frame 1210. However, as shown in image 1220, two edges of cubic face 1212 are discontinuous with neighboring cubic faces as indicated by ellipses 1230 and 1232. Various techniques to generate continuous padding are disclosed as follows.

In the first example, cubic face 1212 is partitioned into multiple regions. As shown in FIG. 12, three sides (i.e., “A”, “B” and “C”) of the target cubic face share the same cubic-face edges with the bottom cubic faces of cubic frame 1210. Therefore, target cubic face 1310 is partitioned into regions 1, 2 and 3 as shown in FIG. 13. The three partitioned regions are placed below the cubic frame as shown in image 1320. The partitioned target cubic face 1310 consists of one isosceles triangle (i.e., region 2) and two right-angle triangles (i.e., regions 1 and 3). The height of the isosceles triangle has a shared cubic-face edge (i.e., edge B as shown in corresponding FIG. 12). This side is considered as a base side and the height, h1 of the isosceles triangle is indicated by an arrow. Each right-angle triangle has a long side (i.e., edge A or Edge C as shown in corresponding FIG. 12) and a short side adjacent to the right angle. The length of the long side is equal to the length of the cubic-face edge. The length, h2 of the short side is equal to half of the length of the cubic-face edge. In the padding area 1320, the heights of the three triangles are adjusted to have the same height. In other words, adjust height, h1′ is the same as the adjusted height h2′ as shown in FIG. 13. The areas between the partitioned regions can be interpolated as shown by the arrows. Also, the areas between partitioned regions can be assigned the same pixel value along each line indicated by an arrow, where the pixel value may correspond to a value of one of the two boundary pixels of the neighboring partitioned regions.

FIG. 14 illustrates another example of continuous padding using a target cubic face. Image 1410 in FIG. 14 corresponds to an image filled with extended cubic faces sharing common edges. As indicated by ellipses 1412 and 1414, discontinuities exist between two neighboring extended cubic faces. A continuous padding technique as shown in FIG. 13 can be applied. The target cubic edges on the right side of the cubic frame are labeled (i.e., “A”, “B”, “C” and “D”). These four edges correspond to the four edges of cubic image 1430. Similar to the example of FIG. 13, cubic face 1430 is partitioned into multiple regions. As shown in FIG. 15, target cubic face 1430 is partitioned into regions 1, 2 and 3 as shown in FIG. 15, where the partitioned cubic face 1510 is indicated. The three partitioned regions are placed to the right side of the cubic-face frame as shown in image 1520. The areas between the partitioned regions can be interpolated as shown by the arrows. Also, the areas between partitioned regions can be assigned the same pixel value along each line indicated by an arrow, where the pixel value may correspond to a boundary value of one of the two neighboring partitioned regions.

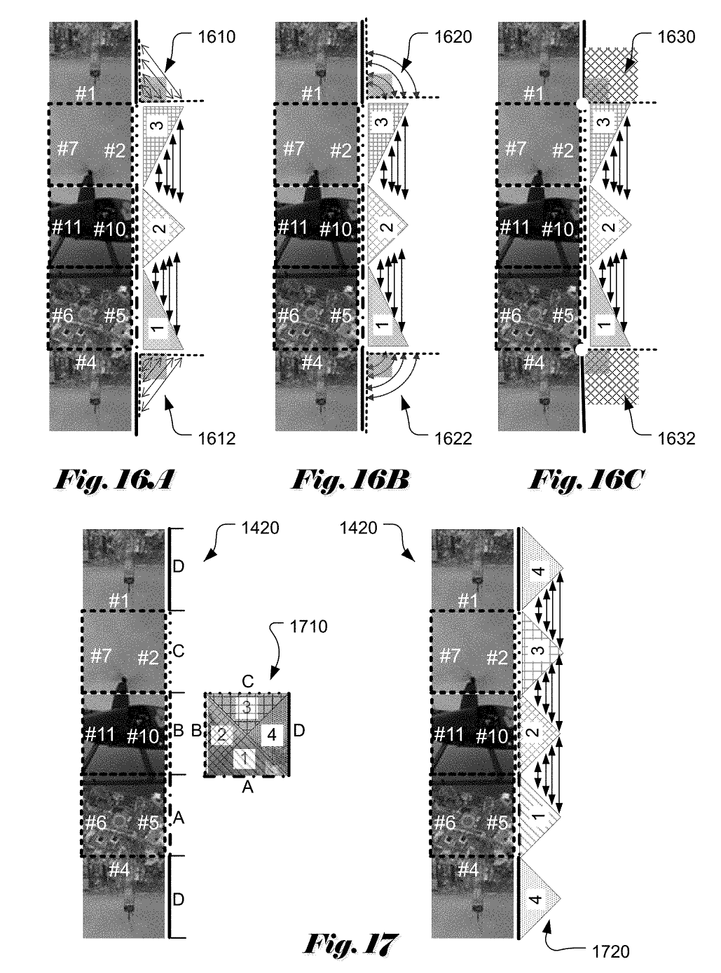

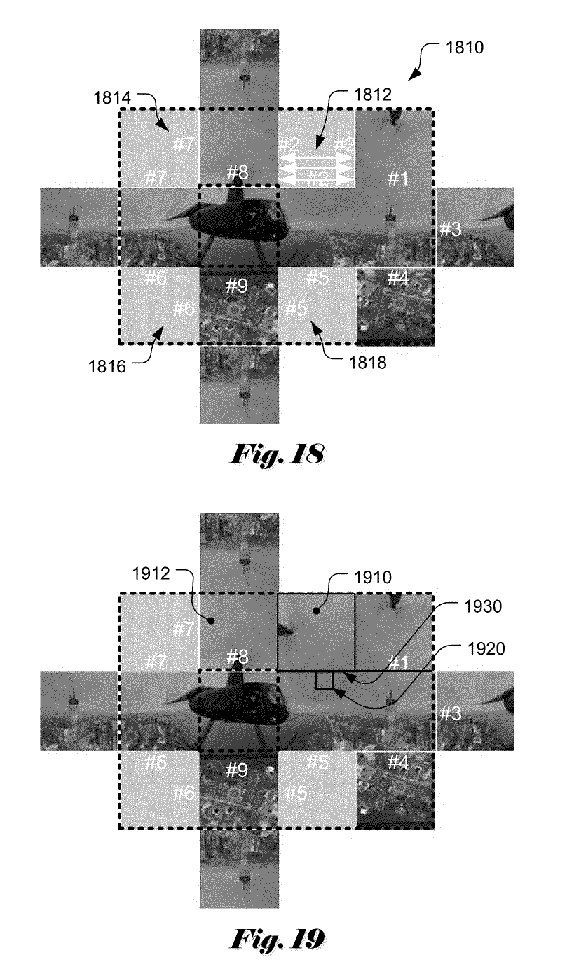

In FIG. 15, there is no converted cubic face for the areas to the right side of cubic edges D., which is a similar issue as that illustrated in FIG. 4 and FIG. 5. The techniques illustrates in FIG. 6A through FIG. 6D can be applied to resolved the issue. Accordingly, line-based padding is shown in FIG. 16A to fill corner areas 1610 and 1612; circular-based padding is shown in FIG. 16B to fill corner areas 1620 and 1622; and point-based padding is shown in FIG. 16C to fill corner areas 1630 and 1632.

FIG. 17 illustrates yet another continuous padding technique, where the cubic face is equally partitioned into four equal-sized isosceles triangles 1710, and the base side (labelled as A, B, C or D) of each triangle is associated with one cubic-face edge on the right side cubic boundary of image 1420. Accordingly, these four partitioned regions 1720 are filled into the right side of cubic frame 1420. The areas between the partitioned regions can be filled using interpolation.

FIG. 18 illustrates another example of padding required for an unfolded cubic net 1810. There are blank areas (1812 to 1818) after filling areas next to shared cubic edges with corresponding cubic faces. In one embodiment, the blank area can be filled using interpolation. For example, boundary pixels from the edge can be used to interpolate or can be copied along the lines indicated for area 1812.

In another embodiment, a cubic face can be used to fill the blank area as shown in FIG. 19. In this example, a cubic face 1912 is rotated clockwise and is placed in area 1910. The rotated cubic face 1910 is continuous across cubic-face boundary 1930. For a current block 1920 to be processed, the block may use surrounding data across boundary 1930.

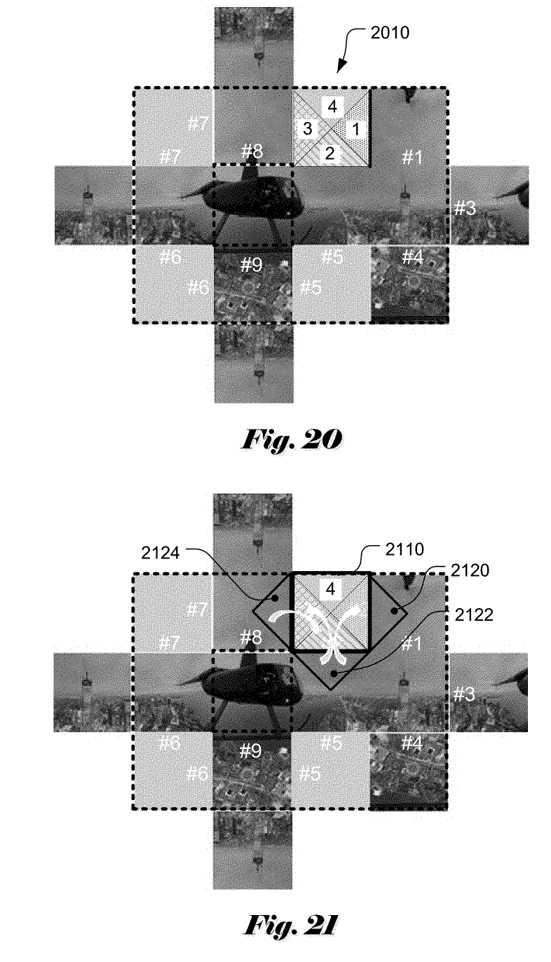

In another embodiment, the blank area can be divided into multiple regions and each region is padded independently as shown in FIG. 20, where the blank area is partitioned into four region 2010 (areas 1, 2, 3 and a blank area).

The blank area can also be filled with a boundary cubic face (named a padding face) for each cubic edge. For example, the pixels in an area of a boundary face can be used to fill a region of the blank area. FIG. 21 illustrates an example of partitioning a blank area into regions and filling each region using a boundary cubic face. In FIG. 21, blank area 2110 is to be filled and the blank area is partitioned into four regions in a same manner as shown in FIG. 20. For regions 1, 2 and 3, a region (2120, 2122 or 2124) of corresponding boundary cubic face is extended to fill the respective blank region (i.e., regions 1, 2 or 3 respectively). In one example, the region (2120, 2122 or 2124) of corresponding boundary cubic face can be flipped with respect to the respective cubic edge as indicated by the curved arrows and to fill the respective blank region (i.e., regions 1, 2 or 3 respectively).

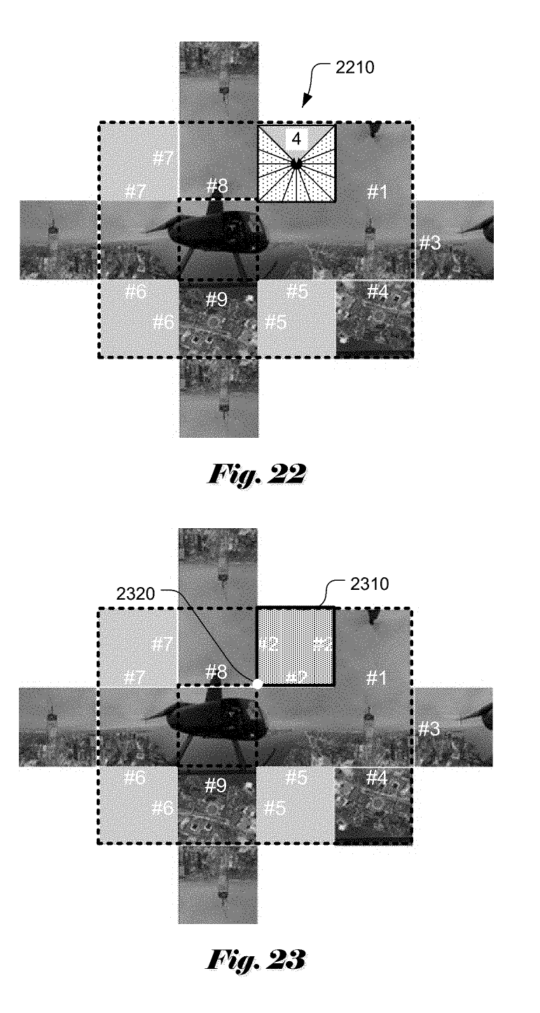

FIG. 22 illustrates yet another example of filling the blank area using boundary cubic faces. In FIG. 22, the blank area is partitioned into four regions in a same manner as that shown in FIG. 20. For each region of the blank area, a same pixel value is assigned for each line in the blank area. The pixel value may be a corresponding boundary pixel value or a pre-defined value.

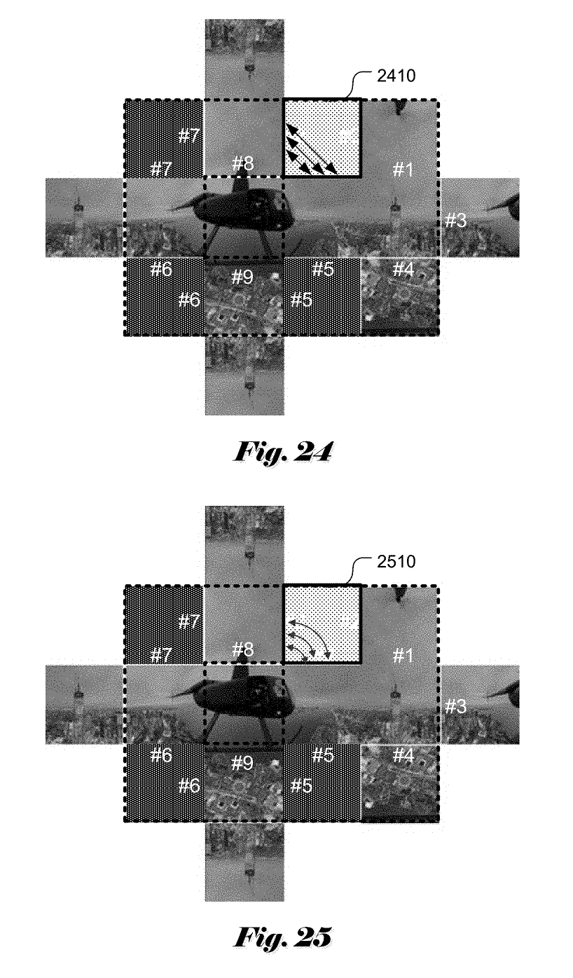

Other padding techniques mention earlier can be applied to this case as well. For example, FIG. 23 illustrates a point-based padding, where the value of corner pixel 2320 or a pre-define value is used to fill the area 2310. FIG. 24 illustrates line-based padding, where interpolation can be performed along lines using boundary pixel values to fill area 2410. Also, a boundary pixel value or a pre-define value can be used each line to fill area 2410. FIG. 25 illustrates circular-based padding, where interpolation can be performed along circular lines using boundary pixel values to fill area 2510. Also, a boundary pixel value or a pre-define value can be used for each circular line to fill area 2510.

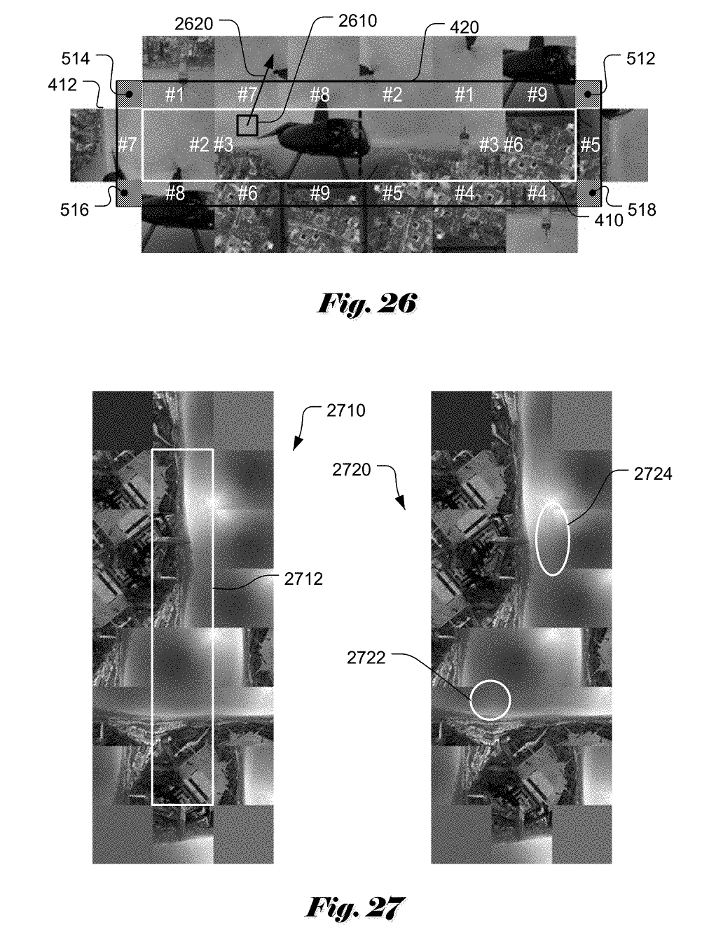

The padding techniques usually fill neighboring areas around the boundaries so that when pixel data outside the frame boundaries are needed, the required data will be available for processing. For example, a filtering process may require up neighboring pixel around a current pixel. If the current pixel is close to or at the boundary of an image, some neighboring data may not be available. The padding process will generate the required neighboring data. For Inter prediction in video coding, reference data as indicated by a motion vector can be used as reference data. When a current block is near the boundary, the required reference data may be outside the image boundary. The padding process can help to generate the required reference data. Nevertheless, large motion may occur, which will point to data beyond the padded area. FIG. 26 illustrates an example of large MV, where the padding technique in FIG. 5 is used as an example. Block 2610 corresponds to a current block. Move vector 2620 for the current block points to a faraway area beyond the padded region 420. According to one embodiment, if the motion vector is out of the cubic padding region 420, the reference pixels are replicated from the boundary pixels of the cubic padding image.

In the cubic face representation, the different cubic faces may have been captured by different cameras and/or have gone through different processing, which may cause artifact in padding along cubic frame boundary. The present invention also discloses padding techniques that utilize filtering to reduce the visible artifact along the cubic frame boundary. The filtering may correspond to smooth filtering or deblocking. FIG. 27 illustrates an example of a padded cubic-face frame having artifact. Image 2710 corresponds to a padded cubic-face frame, where rectangle 2712 indicates the boundary of the cubic-face frame. Image 2720 indicates some artifacts (2722 and 2724) in the padded cubic-face frame.

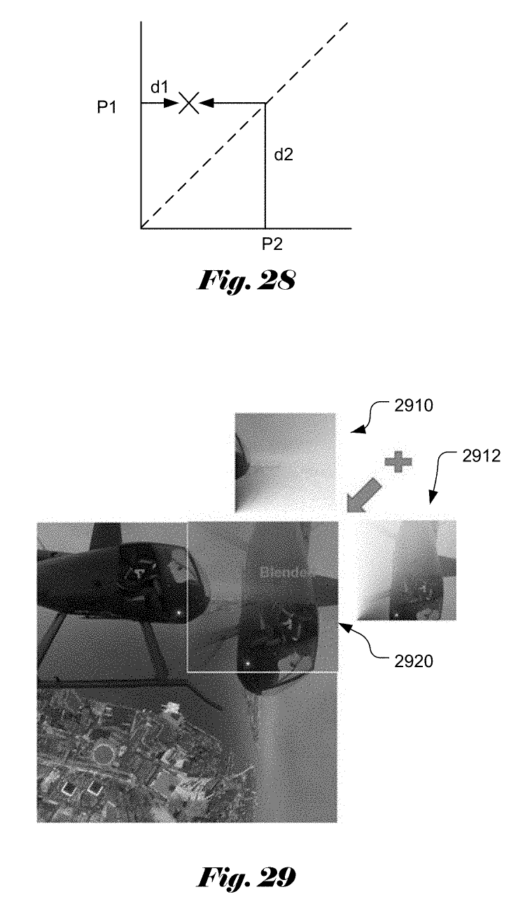

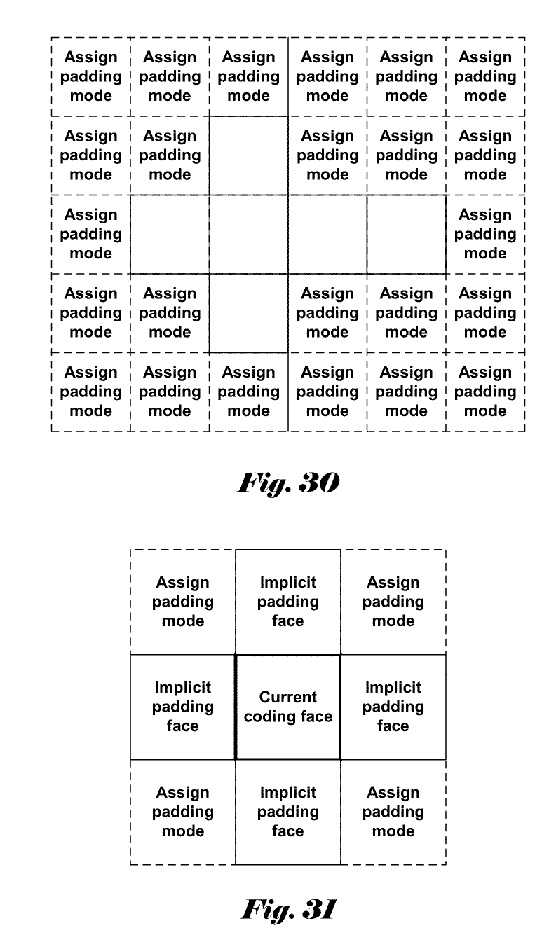

In one embodiment, alpha blending is used to reduce the artifact. In particular, alpha blending is applied to extended cubic faces along to different directions. A weighted sum is used to determine the filtered pixel value. FIG. 28 illustrates an example of determining the weights for the alpha blending. For pixel “X”, the distance from boundary pixel P1 to the current pixel “X” is d1 and the distance from another boundary pixel P2 to the current pixel “X” is d2. The weighting factors are derived as d2/(d1+d2) and d1/(d1+d2). FIG. 29 illustrates an example of applying alpha blending to two neighboring cubic faces (2910 and 2912) to form a blended cubic face 2920.

The present invention also discloses a technique to signal padding modes. As mentioned about, there are various padding techniques available to generate a padded cubic-face frame. No particular padding technique can guarantee to always provide the best result. Accordingly, an embodiment of the present invention allows the encoder to select a best padding for an ambiguous cubic face, where the best padding is unknown. FIG. 30 illustrates an example of assigning padding modes for each padding region in a layout scheme, where dash-lines blocks indicate regions or areas to be padded. FIG. 31 illustrates another example of assigning padding mode. In this example, each face is coded and creates padding independently. The four adjacent faces of the current face are connected first and padding modes are assigned for other regions.

The inventions disclosed above can be incorporated into various video encoding or decoding systems in various forms. For example, the inventions can be implemented using hardware-based approaches, such as dedicated integrated circuits (IC), field programmable logic array (FPGA), digital signal processor (DSP), central processing unit (CPU), etc. The inventions can also be implemented using software codes or firmware codes executable on a computer, laptop or mobile device such as smart phones. Furthermore, the software codes or firmware codes can be executable on a mixed-type platform such as a CPU with dedicated processors (e.g. video coding engine or co-processor).

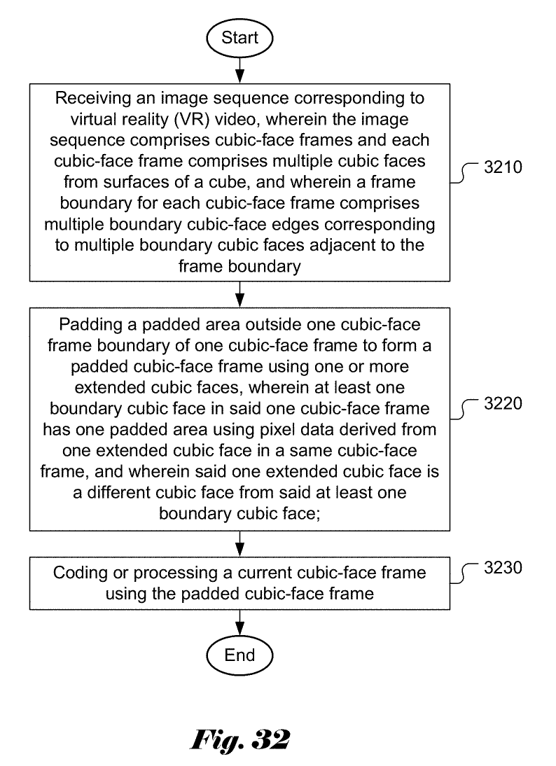

FIG. 32 illustrates an exemplary flowchart of video coding or processing for an image sequence corresponding to virtual reality (VR) video according to an embodiment of the present invention. According to this method, an image sequence corresponding to virtual reality (VR) video is received in step 3210, wherein the image sequence comprises cubic-face frames and each cubic-face frame comprises multiple cubic faces from surfaces of a cube, and wherein a frame boundary for each cubic-face frame comprises multiple boundary cubic-face edges corresponding to multiple boundary cubic faces adjacent to the frame boundary. A padded area outside one cubic-face frame boundary of one cubic-face frame is generated to form a padded cubic-face frame using one or more extended cubic faces in step 3220, wherein at least one boundary cubic face in said one cubic-face frame has one padded area using pixel data derived from one extended cubic face in a same cubic-face frame, and wherein said one extended cubic face is a different cubic face from said at least one boundary cubic face. A current cubic-face frame is then coded or processed using the padded cubic-face frame in step 3230.

The above flowcharts may correspond to software program codes to be executed on a computer, a mobile device, a digital signal processor or a programmable device for the disclosed invention. The program codes may be written in various programming languages such as C++. The flowchart may also correspond to hardware based implementation, where one or more electronic circuits (e.g. ASIC (application specific integrated circuits) and FPGA (field programmable gate array)) or processors (e.g. DSP (digital signal processor)).

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method for video coding or processing for an image sequence corresponding to virtual reality (VR) video, the method comprising:
receiving an image sequence corresponding to virtual reality (VR) video, wherein the image sequence comprises cubic-face frames and each cubic-face frame comprises multiple cubic faces from surfaces of a cube, and wherein a frame boundary for each cubic-face frame comprises multiple boundary cubic-face edges corresponding to multiple boundary cubic faces adjacent to the frame boundary;
padding a padded area outside one cubic-face frame boundary of one cubic-face frame to form a padded cubic-face frame using one or more extended cubic faces, wherein at least one boundary cubic face in said one cubic-face frame has one padded area using pixel data derived from one extended cubic face in a same cubic-face frame, and wherein said one extended cubic face is a different cubic face from said at least one boundary cubic face; and
coding or processing a current cubic-face frame using the padded cubic-face frame.

2. The method of claim 1, wherein said one cubic-face frame corresponds to one 1×6 cubic layout, 2×3 cubic layout, 3×2 cubic layout or a cubic net with blank areas.

3. The method of claim 1, wherein said coding the current cubic-face frame uses Inter prediction and said one cubic-face frame corresponds to one reference cubic-face frame coded prior to the current cubic-face frame.

4. The method of claim 1, wherein if a current block in the current cubic-face frame is coded using Inter prediction and a motion vector of the current block points to reference pixels outside the padded cubic-face frame, the reference pixels outside the padded cubic-face frame are replicated from one or more boundary pixels of the padded cubic-face frame.

5. The method of claim 1, wherein for a target boundary cubic-face edge, one extended cubic face sharing the target boundary cubic face edge with a corresponding boundary cubic face is copied to a corresponding padded area for the corresponding boundary cubic face.

6. The method of claim 5, wherein if one or more corner areas at corners of the padded area has no corresponding boundary cubic face to derive padded data, one or more neighboring boundary cubic faces are used to derive pixel data in one corner area.

7. The method of claim 6, wherein line-based padding, circular-based padding, point-based padding or area-based padding is used to derive the pixels data in one corner of the padded area.

8. The method of claim 6, wherein when line-based padding is used, a line connecting two corresponding boundary pixels from two neighboring cubic faces of one corner area is assigned a same pixel value.

9. The method of claim 6, wherein when circular-based padding is used, a circular curve connecting two corresponding boundary pixels from two neighboring cubic faces of one corner area is assigned a same pixel value, and wherein said same pixel value corresponds to a pixel value of one of the two corresponding boundary pixels or a weighted sum of the two corresponding boundary pixels.

10. The method of claim 6, wherein when point-based padding is used, one corner area is assigned a same pixel value corresponding to a pixel value of a corner pixel or another pixel in two neighboring cubic faces of said one corner area.

11. The method of claim 10, wherein the pixel value corresponds to one boundary pixel after filtering.

12. The method of claim 5, wherein when area-based padding is used, one corner area is filled using one of two neighboring cubic faces of said one corner area, or said one corner area is split into two sub-corner areas and filled with corresponding sub-cubic faces of said two neighboring cubic faces.

13. The method of claim 1, wherein a target extended cubic face sharing one or more boundary cubic-face edges with one or more corresponding boundary cubic faces is used to derive a corresponding padded area for a target side of the corresponding boundary cubic face, and wherein said one or more boundary cubic-face edges align with the target side of the corresponding boundary cubic face.

14. The method of claim 13, wherein the target extended cubic face is partitioned into multiple regions and each region comprises one cubic-face edge of the target extended cubic face, and wherein each region is used to fill a corresponding padded region for a boundary cubic face sharing a same cubic-face edge with said each region.

15. The method of claim 14, wherein heights of the multiple regions measured from the frame boundary are adjusted to be a same height.

16. The method of claim 14, wherein a blank region between two padded regions is filled by using interpolation from two corresponding boundary pixels of said two padded regions or by using a same value along each line connecting two corresponding boundary pixels of said two padded regions, and wherein said same value corresponds to one of two pixel values of two boundary pixels of the two padded regions.

17. The method of claim 14, wherein a corner area adjacent to one extended cubic face and one padded region filled by one region of the target extended cubic face is filled using line-based padding, circular-based padding or point-based padding according to boundary pixels or a corner pixel of one or more neighboring cubic faces.

18. The method of claim 14, wherein if a total number of different boundary cubic-face edges shared between said one or more corresponding boundary cubic faces and the target extended cubic face is three: the target extended cubic face is partitioned into one first triangle and two second triangles, wherein the first triangle corresponds to an isosceles triangle having one boundary cubic-face edge as a base side and having a first height of isosceles triangle equal to a length of one cubic-face edge; each second triangle corresponds to one right-angle triangle having one boundary cubic-face edge as a long adjacent side to a right angle and a length of a short adjacent side to the right angle is equal to a half of the length of one cubic-face edge, wherein the second triangle has a second height equal to one half of the length of one cubic-face edge when the long adjacent side is considered as a base side to fill a padded region for one boundary cubic face sharing one cubic-face edge; and the first height and the second height are adjusted to be the same.

19. The method of claim 14, wherein if a total number of different boundary cubic-face edges shared between said one or more corresponding boundary cubic faces and the target extended cubic face is four: the target extended cubic face is partitioned into four equal-sized isosceles triangles, wherein each triangle has one boundary cubic-face edge as a base side and having a first height of isosceles triangle equal to half length of one cubic-face edge.

20. The method of claim 1, wherein if the cubic-face frame corresponds to a cubic net with blank areas, at least one blank area is padded using one extended cubic face.

21. The method of claim 20, wherein for a target block in a target boundary cubic face being coded or processed, said one extended cubic face is used to fill said at least one blank area, wherein said one extended cubic face is selected to share a same cubic-face edge with the target boundary cubic face.

22. The method of claim 20, wherein said one blank area is partitioned into multiple blank regions and each blank region is padded using one corresponding boundary cubic face sharing one cubic edge with said each blank region.

23. The method of claim 22, wherein a corresponding region of said one corresponding boundary cubic face is used to fill said each blank region.

24. The method of claim 1, wherein when one extended cubic face is used to fill one blank area or a partial blank area, alphas blending is applied along two neighboring shared cubic-face edges.

25. The method of claim 24, wherein a weighting factor for alpha blending is determined according to perpendicular distances to a starting point of extension.

26. The method of claim 1, further comprising signaling or parsing one or more padding modes assigned to each padding area or region.

27. The method of claim 26, wherein padding modes for neighboring cubic faces are determined and a current padding mode for a current cubic face is signaled or parsed only if the current padding mode is ambiguous.

28. An apparatus for video coding or processing for an image sequence corresponding to virtual reality (VR) video, the apparatus comprising one or more electronics or processors arranged to:
receive an image sequence corresponding to virtual reality (VR) video, wherein the image sequence comprises cubic-face frames and each cubic-face frame comprises multiple cubic faces from surfaces of a cube, and wherein a frame boundary for each cubic-face frame comprises multiple boundary cubic-face edges corresponding to multiple boundary cubic faces adjacent to the frame boundary;
pad a padded area outside one cubic-face frame boundary of one cubic-face frame to form a padded cubic-face frame using one or more extended cubic faces, wherein at least one boundary cubic face has one padded area using pixel data derived from one extended cubic face in a same cubic-face frame, and wherein said one extended cubic face is a different cubic face from said at least one boundary cubic face; and
code or process a current cubic-face frame using the padded cubic-face frame.
